(19) United States
(12) Patent Application Publication
(10) Pub. No.: US 2016/0372057 A1
(43) Pub. Date: Dec. 22, 2016

(54) IMAGE PROCESSING APPARATUS, IMAGE PROCESSING METHOD AND IMAGE DISPLAY APPARATUS

(71) Applicant: SONY CORPORATION, Tokyo (JP)

(72) Inventors: YOSHIHIRO KATSU, KANAGAWA (JP); KUNINORI MIYAZAWA, KANAGAWA (JP); KENKOU HONDA, KANAGAWA (JP); YUSUKE CHIBA, TOKYO (JP)

(21) Appl. No.: 15/121,444

(22) PCT Filed: Mar. 2, 2015
(86) PCT No.: PCT/JP2015/001081

§ 371 Date: Aug. 25, 2016

(30) Foreign Application Priority Data
Mar. 5, 2014 (JP) 2014-042857
Dec. 4, 2014 (JP) 2014-245564

(51) Int. Cl. G09G 3/34; G09G 3/36

(52) U.S. Cl. CPC G09G 3/3426; G09G 3/36; G09G 3/3413; G09G 2320/0276; G09G 2320/0646; G09G 2320/066; G09G 2320/0673; G09G 2360/141

(57) ABSTRACT

An image processing apparatus may include a processing device that determines a degree of degeneracy of high luminance signal information of an input image, and obtains a luminance signal curve based on the degree of degeneracy.

### CROSS REFERENCE TO RELATED APPLICATIONS

This application claims the benefit of Japanese Priority Patent Application JP 2014-042857 filed Mar. 5, 2014, and Japanese Priority Patent Application JP 2014-245564 filed Dec. 4, 2014, the entire contents of each of which are incorporated herein by reference.

### TECHNICAL FIELD

A technology which is disclosed in the present disclosure relates to an image processing device and an image processing method which perform a luminance dynamic range conversion process of an image, and an image display device.

### BACKGROUND ART

In recent years, a technology of high dynamic range (HDR) imaging is progressing due to a high bit of an imaging element (image sensor), or the like. The HDR is a technology which aims to express an image which is closer to the real world, and there is an advantage that it is possible to realistically express a shade, to simulate an exposure, to express glare, or the like. Meanwhile, since in a standard dynamic range (SDR) image, high brightness information is compressed using photographing or editing, the dynamic range becomes small, and it is difficult to say that it is expressing the real world.

For example, an imaging apparatus in which an HDR image composed from a plurality of imaged images of which exposure amounts are different is presented (for example, refer to PTL 1).

A camera which is used in contents production usually has an ability to photograph an HDR image. However, the reality is that an image is converted into an image of which a dynamic range is compressed into standard luminance of approximately 100 nit, is edited, and then is provided to a content user. Forms of providing contents are various, and there are digital broadcasting, a streaming delivery through the Internet, media selling, and the like. For a content producer, white luminance of a master monitor which is used in editing of contents is approximately 100 nit, high luminance signal information at a time of original producing is compressed, gradation thereof is damaged, and realistic sensation is lost.

In addition, it is possible to perform a luminance dynamic range conversion in which an image is converted from an HDR image into an SDR image using Knee compression. The Knee compression is a process in which a high luminance portion of a signal is suppressed so that luminance of an image falls within a predetermined dynamic range (here, dynamic range of SDR). The Knee compression is a method in which a dynamic range is compressed with respect to a luminance signal which exceeds a predetermined luminance signal level which is referred to as a Knee point by decreasing an inclination of input-output characteristics (for example, refer to PTL 2). The Knee point is set so as to be lower than a desired maximum luminance signal level.

In recent years, a high luminance display with a maximum luminance of 500 nit or 1000 nit has been commercially available. However, as described above, since an image is provided after being compressed into a dynamic range of an SDR image, regardless of the fact that the image is produced as an HDR Image, originally, there is waste of viewing an SDR image using a high luminance display which is brighter than a master monitor of which white luminance is 100 nit.

In order to enjoy an SDR image which is provided in a form of television broadcasting, streaming, or media as the original HDR Image using a high luminance display, a Knee extension process may be performed. When performing Knee extension, a reverse process to a Knee compression process may be performed. A method of the Knee compression can be defined using an input luminance position and an output luminance position at which a suppression of a Knee point, that is, suppressing of a signal level is started, and a maximum luminance level which is suppressed. However, when definition information of Knee compression is delivered only as an incomplete form, or is not delivered at all from a broadcasting station (or supply source of image), it is not possible to ascertain an accurate method of performing Knee extension on the receiver side. When the extension process of the luminance dynamic range is performed in an inaccurate method, there is a problem in that it is not possible to restore the compressed high luminance signal information, and not to restore Knee compression when performing editing.

### CITATION LIST

### Patent Literature

### [PTL 1]

### Japanese Unexamined Patent Application Publication No. 2013-255301

### [PTL 2]

### Japanese Unexamined Patent Application Publication No. 2006-211095

### [PTL 3]

### Japanese Unexamined Patent Application Publication No. 2008-134318

### [PTL 4]

### Japanese Unexamined Patent Application Publication No. 2011-221196

### [PTL 5]

### Japanese Unexamined Patent Application Publication No. 2014-178489

### [PTL 6]

### Japanese Unexamined Patent Application Publication No. 2011-18619

### SUMMARY

### Technical Problem

It is desirable to provide an excellent image processing device and an image processing method which can convert an image which is compressed so as to be in a low dynamic range or a standard dynamic range into the original high dynamic range image, and an image display device.

### Solution to Problem

According to an embodiment of the present disclosure, an image processing apparatus may include a processing device that determines a degree of degeneracy of high luminance signal information of an input image, and obtains a luminance signal curve based on the degree of degeneracy.

According to an embodiment of the present disclosure, an image processing method may include determining, by a processing device, a degree of degeneracy of high luminance signal information of an input image, and obtaining, by the processing device, a luminance signal curve based on the degree of degeneracy.

According to an embodiment of the present disclosure, a non-transitory storage medium may be recorded with a program for image processing, and the program may include determining a degree of degeneracy of high luminance signal information of an input image, and obtaining a luminance signal curve based on the degree of degeneracy.

According to an embodiment of the present disclosure, a display apparatus may include a processing device that determines a degree of degeneracy of high luminance signal information of an input image, and obtains a luminance signal curve based on the degree of degeneracy; and a display device including a backlight configured by a plurality of light emission units, where the processing device controls power of the individual light emission units, in accordance with the luminance signal curve.

According to an embodiment of the present disclosure, there is provided an image processing device which includes a determination unit which determines a degree of degeneracy of high luminance signal information of an input image; and an adjusting unit which adjusts the input image based on a determination result using the determination unit.

In the image processing device, the adjusting unit may include a luminance correction unit which corrects luminance based on the determination result using the determination unit; a luminance signal correction unit which corrects a luminance signal according to gradation; and a color signal correction unit which corrects a change in hue which is associated with the correction of the luminance signal as necessary.

In the image processing device, the luminance correction unit may improve luminance in all gradations according to a degree of degeneracy of high luminance signal information which is determined by the determination unit.

In the image processing device, the luminance signal correction unit may optimize a signal curve with respect to gradation which is degenerated, and gradation which is not degenerated.

In the image processing device, the color signal correction unit may maintain original hue by performing a reverse correction with respect to a change when the hue is changed associated with the correction of the luminance signal which is performed using the luminance signal correction unit.

In the image processing device, the color signal correction unit may correct a chroma signal so that a ratio of a luminance signal to the chroma signal becomes constant before and after correcting the luminance signal.

In the image processing device, the determination unit may determine a degree of degeneracy of the high luminance signal information thereof based on a luminance level of an input image.

In the image processing device, the determination unit may determine the degree of degeneracy of the high luminance signal information based on at least one of a maximum luminance signal level in an input image, an amount in the vicinity of a value of the maximum luminance signal level in the input image, a mean value of the luminance signal in the input image, and an amount in the vicinity of a value of a black (low luminance signal) level in the input image.

According to another embodiment of the present disclosure, there is provided an image processing method which includes determining a degree of degeneracy of high luminance signal information of an input image; and adjusting the input image based on a determination result in the determining.

According to still another embodiment of the present disclosure, there is provided an image display device which includes a determination unit which determines a degree of degeneracy of high luminance signal information of an input image; an adjusting unit which adjusts the input image based on a determination result using the determination unit; and a display unit which displays the image which is adjusted.

### Advantageous Effects of Present Disclosure

According to a technology which is disclosed in the present disclosure, it is possible to provide excellent image processing device and image processing method which can reproduce brightness in real space by converting an image which is compressed so as to be in a low dynamic range or a standard dynamic range into the original high dynamic range image, and an image display device.

In addition, an effect which is described in the present disclosure is merely an example, and an effect of the technology is not limited to this. In addition, there is a case in which an additional effect is exerted, in addition to the above described effect in the technology.

Further another object, characteristics, or advantage of the technology which is disclosed in the present disclosure may become clear using further detailed descriptions based on embodiments which will be described later, or accompanying drawings.

### BRIEF DESCRIPTION OF DRAWINGS

FIG. 1 is a diagram which schematically illustrates a configuration example of an image display device to which the technology which is disclosed in the present disclosure is applied.

FIG. 2 is a diagram which schematically illustrates a configuration example when a display unit is a liquid crystal display method.

FIG. 3 is a diagram which illustrates a schematic processing procedure, which is presented in the present disclosure, for converting an image in a low luminance dynamic range or a standard luminance dynamic range into a high dynamic range image.

FIG. 4 is a diagram which illustrates a state in which an input image is subjected to a luminance correction.

FIG. 5 is a diagram which illustrates a state in which luminance of an input image after the luminance correction is optimized using a luminance signal correction.

FIG. 6 is a diagram which illustrates a functional configuration in which a chroma signal is corrected so that a ratio of a luminance signal to the chroma signal becomes constant before and after correcting the luminance signal.

FIG. 7 is a diagram which describes partial driving and a technology of thrusting.

FIG. 8 is a diagram which describes partial driving and the technology of thrusting.

FIG. 9 is a diagram which describes partial driving and the technology of thrusting.

FIG. 10 is a diagram which schematically illustrates a configuration example of the image processing device to which the technology which is disclosed in the present disclosure can be applied.

FIG. 11 is a diagram which schematically illustrates a configuration example of the image processing device to which the technology which is disclosed in the present disclosure can be applied.

FIG. 12 is a diagram which schematically illustrates a configuration example of the image processing device to which the technology which is disclosed in the present disclosure can be applied.

FIG. 13 is a diagram which exemplifies a luminance signal histogram of an input image.

FIG. 14 is a diagram which exemplifies a table in which a degree of degeneracy K₁ of a high luminance signal information with respect to the maximum luminance signal level is described.

FIG. 15 is a diagram which exemplifies a table in which a degree of degeneracy K₂ of a high luminance signal information with respect to an amount in the vicinity of a value of the maximum luminance signal level is described.

FIG. 16 is a diagram which exemplifies a table in which a degree of degeneracy K₃ of a high luminance signal information with respect to a mean value of a luminance signal is described.

FIG. 17 is a diagram which exemplifies a table in which a degree of degeneracy K₄ of a high luminance signal information with respect to an amount in the vicinity of a value of a black level is described.

FIG. 18 is a diagram which illustrates a functional configuration example of performing a luminance signal correction and a color signal correction in an RGB space.

FIG. 19 is a diagram which illustrates a liquid crystal display panel, a backlight, and a configuration of a driving unit thereof in detail.

FIG. 20 is a conceptual diagram which illustrates a part of a driving circuit illustrated in FIG. 19.

FIG. 21 is a diagram which schematically illustrates a configuration example of a direct-type backlight.

FIG. 22 is a view which illustrates a cross section of a light guiding plate with a single layer structure.

FIG. 23A is a diagram which exemplifies a structure of a pixel arrangement.

FIG. 23B is a diagram which exemplifies a structure of a pixel arrangement.

FIG. 23C is a diagram which exemplifies a structure of a pixel arrangement.

FIG. 23D is a diagram which exemplifies a structure of a pixel arrangement.

FIG. 24 is a diagram which schematically illustrates an example of a cross-sectional configuration of an edge light-type backlight in which multilayered light guiding plate is used.

FIG. 25 is a diagram which illustrates a state in which a light emitting surface (light outputting surface) of the backlight which is illustrated in FIG. 24 is viewed from above.

### DESCRIPTION OF EMBODIMENTS

Hereinafter, embodiments of the technology which is disclosed in the present disclosure will be described in detail with reference to drawings.

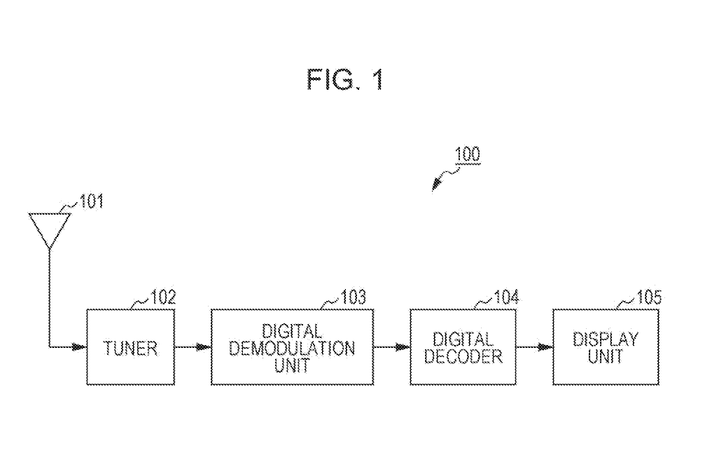

FIG. 1 schematically illustrates a configuration example of an image display device 100 to which the technology disclosed in the present disclosure can be applied.

A transmission radio wave of terrestrial wave digital broadcast, satellite digital broadcast, or the like, is input to an antenna 101. A tuner 102 selectively amplifies a desired radio wave among signals which are supplied from the antenna 101, and performs a frequency conversion. A digital demodulation unit 103 detects a received signal which is subjected to the frequency conversion, demodulates the signal using a method corresponding to a digital modulation method at a time of transmitting (broadcasting station side), and also performs a transmission error correction. A digital decoding unit 104 outputs image signals of Y, Cb, and Cr to a display unit 105 by decoding the digital demodulation signal.

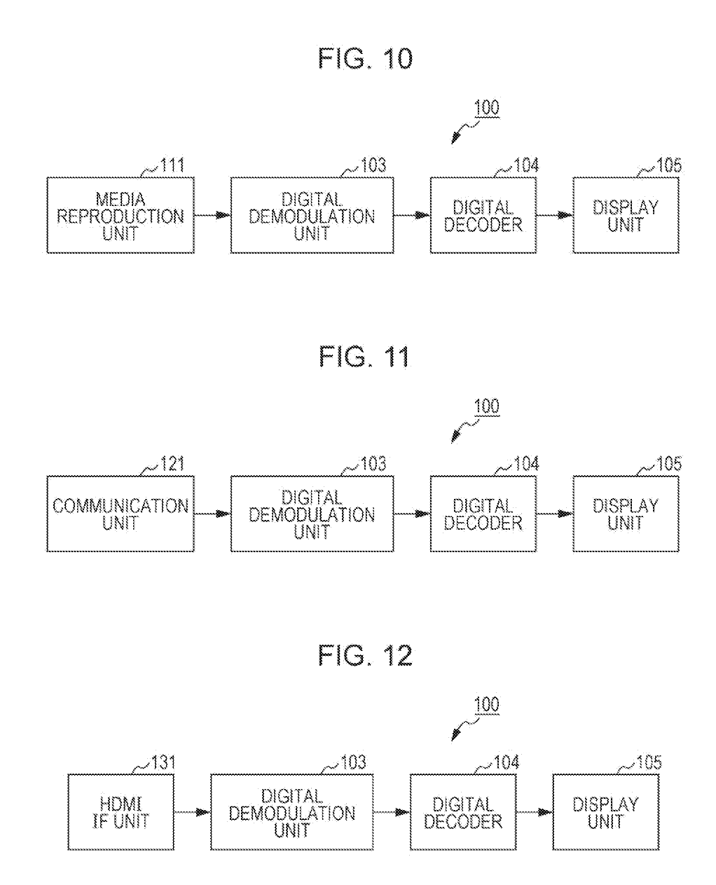

FIG. 10 illustrates another configuration example of the image display device 100 to which the technology disclosed in the present disclosure can be applied. The same configuration elements as those in the apparatus configuration which is illustrated in FIG. 1 are given the same reference numerals. A media reproduction unit 111 reproduces a signal which is recorded in recording media such as a Blu-ray disc, a digital versatile disc (DVD), or the like. A digital demodulation unit 103 detects a reproduction signal, demodulates the reproduction signal using a method corresponding to a digital modulating method at a time of recording, and also performs a correction of transmission errors. A digital decoding unit 104 decodes a digital demodulation signal, and outputs image signal of Y, Cb, and Cr to the display unit 105.

In addition, FIG. 11 illustrates still another configuration example of the image display device 100 to which the technology which is disclosed in the present disclosure can be applied. The same configuration elements as those in the apparatus configuration which is illustrated in FIG. 1 are given the same reference numerals. A communication unit 121 is configured as a network interface card (NIC), for example, and receives a image stream which is delivered through an Internet Protocol (IP) network such as the Internet. The digital demodulation unit 103 detects a reception signal, demodulates the signal using a method corresponding to a digital modulation method at a time of transmitting, and also performs a correction of transmission errors. The digital decoding unit 104 decodes a digital demodulation signal, and outputs image signals of Y, Cb, and Cr to the display unit 105.

In addition, FIG. 12 illustrates still further another configuration example of the image display device 100 to which the technology which is disclosed in the present disclosure can be applied. The same configuration elements as those in the apparatus configuration which is illustrated in FIG. 1 are given the same reference numerals. A high definition multimedia interface (HDMI, registered trademark) unit 131 receives an image signal which is reproduced using a media reproduction device such as a Blu-ray disc player, for example, through an HDMI (registered trademark) cable. The digital demodulation unit 103 detects a reception signal, demodulates the signal using a method corresponding to a digital modulation method at a time of transmitting, and also performs a correction of transmission errors. The digital decoding unit 104 decodes a digital demodulation signal, and outputs image signals of Y, Cb, and Cr to the display unit 105.

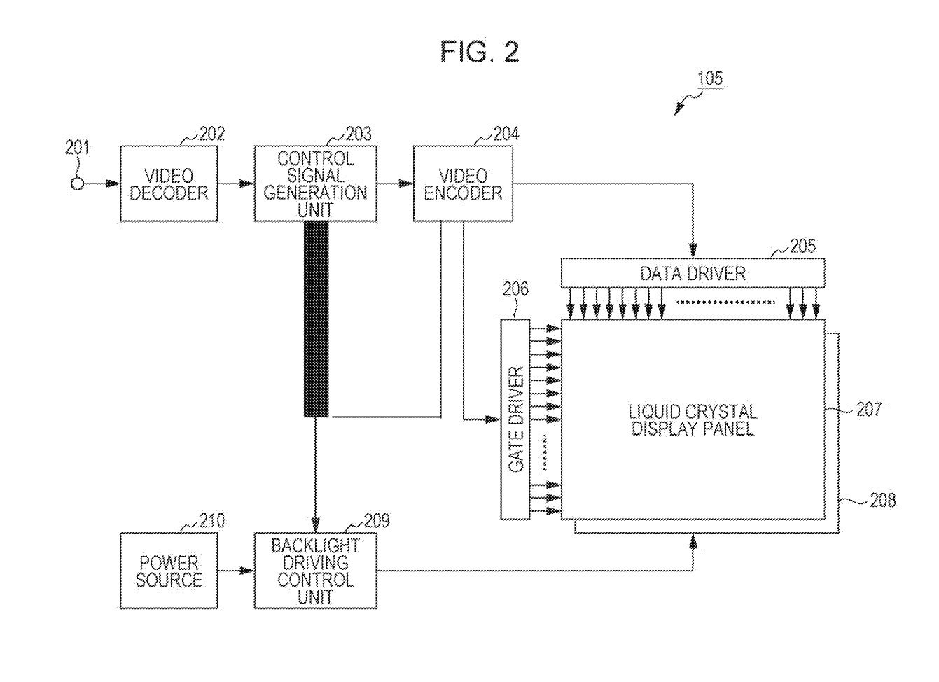

FIG. 2 schematically illustrates an internal configuration example of the display unit 105 of a liquid crystal display method. However, the liquid crystal display method is merely an example, and the display unit 105 may have another method.

A video decoder 202 performs a signal process such as a chroma process with respect to an image signal which is input from the digital decoding unit 104 through an input terminal 201, converts the signal into an RGB image signal with resolution which is appropriate for driving of a liquid crystal display panel 207, and outputs the signal to a control signal generation unit 203 along with a horizontal synchronization signal H and a vertical synchronization signal V.

The control signal generation unit 203 generates image signal data based on the RGB data which is supplied from the video decoder 202, and supplies the data to a video encoder 204 along with the horizontal synchronization signal H and the vertical synchronization signal V. According to the embodiment, the control signal generation unit 203 also performs a process (which will be described later) of converting an image in a low dynamic range or a standard dynamic range into an image in a high dynamic range.

The video encoder 204 supplies each control signal for causing a data driver 205 and a gate driver 206 to be operated in synchronization with the horizontal synchronization signal H and the vertical synchronization signal V. In addition, the video encoder 204 generates a light intensity control signal which individually controls a light emission diode unit of a backlight 208 according to brightness of an image signal, and supplies the light intensity control signal to a backlight driving control unit 209.

The data driver 205 is a driving circuit which outputs a driving voltage based on an image signal, generates a signal to be applied to a data line, based on a timing signal and an image signal which are transmitted from the video encoder 204, and outputs the signal. In addition, the gate driver 206 is a driving circuit which generates a signal for sequential driving, and outputs a driving voltage to a gate-bus line which is connected to each pixel in the liquid crystal display panel 207 according to a timing signal which is transmitted from the video encoder 204.

The liquid crystal display panel 207 has a plurality of pixels which are arranged in a grid shape, for example. Liquid crystal molecules in a predetermined aligning state are enclosed between transparent plates such as glass, and an image is displayed according to application of a signal from the outside. As described above, application of a signal to the liquid crystal display panel 207 is performed using the data driver 205 and the gate driver 206.

The backlight 208 is a surface lighting device which is arranged on the rear side of the liquid crystal display panel 207, irradiates the liquid crystal display panel 207 with light from the rear side, and makes an image which is displayed on the liquid crystal display panel 207 visible. The backlight 208 may have a direct-type structure in which a light source is arranged immediately below the liquid crystal display panel 207, or an edge light-type structure in which the light source is arranged at the periphery of the light guiding plate. As the light source of the backlight 208, it is possible to use a light emitting diode (LED) of R, G, or B, a white LED, or a laser light source.

The backlight driving control unit 209 individually controls brightness in each of the light emission diode units of the backlight 208 according to a light intensity control signal which is supplied from the control signal generation unit 203. The backlight driving control unit 209 can control the light intensity of each of the light emission diode units according to an amount of power which is supplied from the power source 210. In addition, a technology of partial driving (which will be described later) in which a screen is divided into a plurality of lighting regions, and the backlight driving control unit 209 controls brightness of the backlight 208 in each region according to a location of a lighting region and a display signal may be applied.

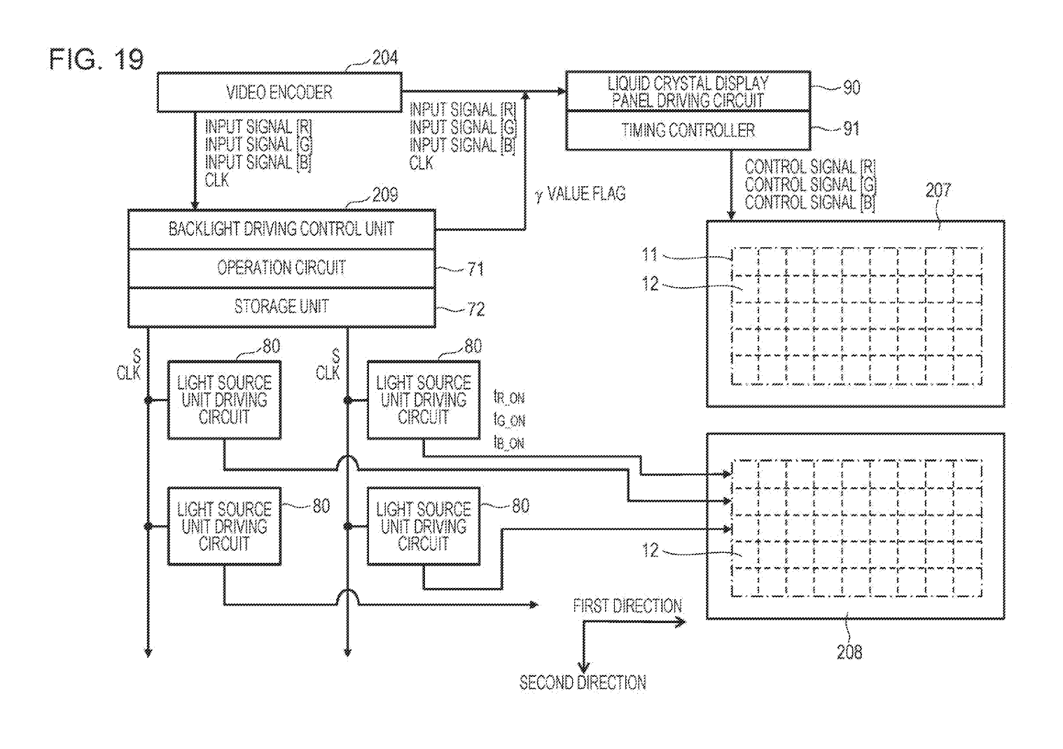

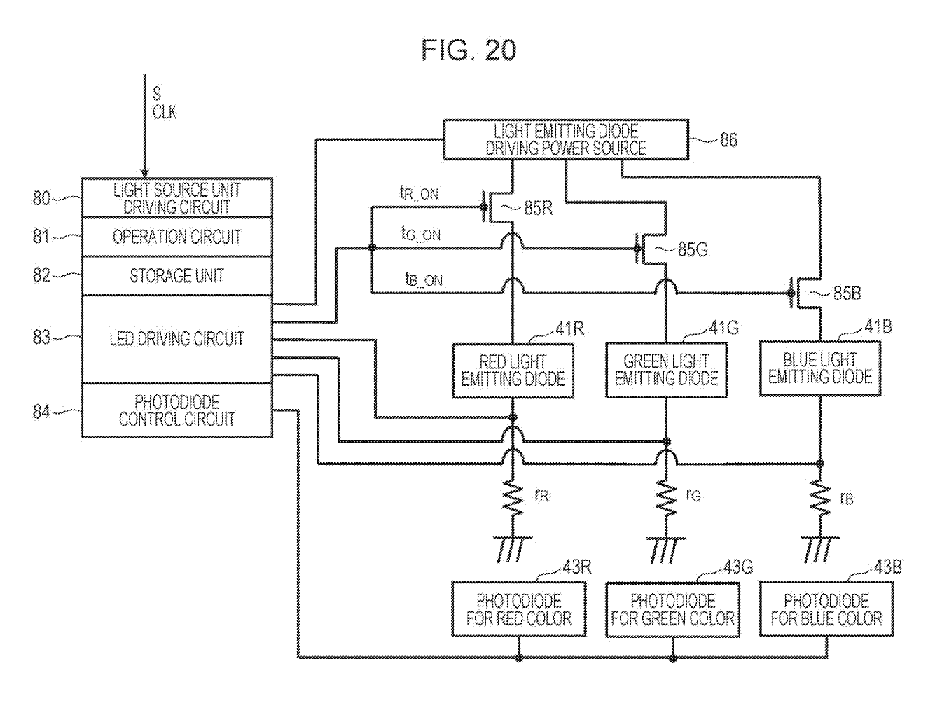

FIG. 19 illustrates the liquid crystal display panel 207 and the backlight 208 in the display unit 105, and a configuration of a driving unit thereof in detail. In addition, FIG. 20 illustrates a conceptual diagram of a part of a driving circuit in FIG. 19. In the illustrated configuration example, it is assumed that it is possible to perform partial driving of the display unit 105.

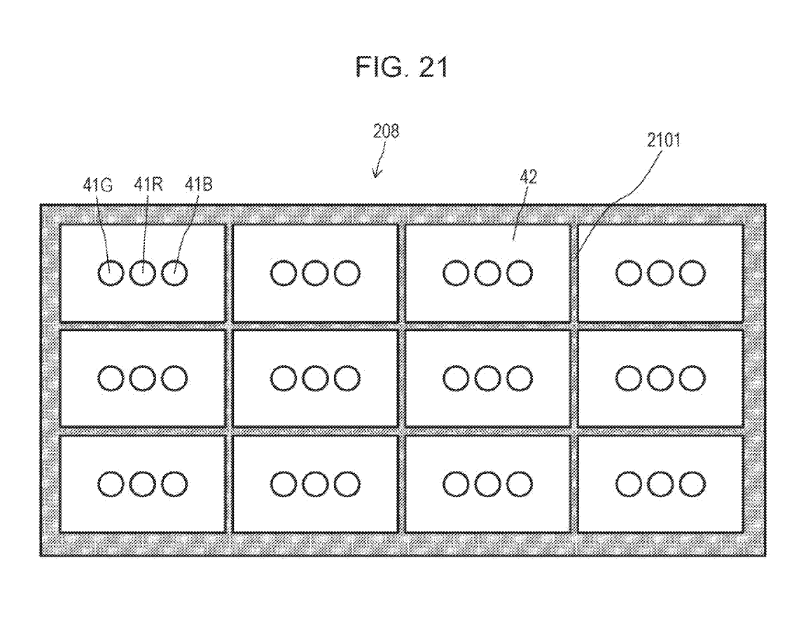

The liquid crystal display panel 207 includes a display region 11 in which total pixels of M₀*N₀, that is, of M₀ pixels along a first direction, and of N₀ pixels along a second direction are arranged in a matrix. Specifically, for example, the display region satisfies an HD-TV standard, as a resolution for image displaying, and for example, (1920, 1080), when the number of pixels M₀*N₀ which are arranged in a matrix is denoted by (M₀, N₀). In addition, when performing partial driving, the display region 11 which is configured of pixels arranged in a matrix (denoted using dot and dash line in FIG. 19) is divided into virtual display region units 12 (boundary is denoted using dotted line) of P*Q. A value of (P, Q) is, for example, (19, 12). However, in order to simplify the figure, the number of display region units 12 (and light source units 42 (refer to FIG. 21) which will be described later) in FIG. 19 is different from this value. Each display region unit 12 is configured of a plurality of (M*N) pixels, and the number of pixels which configure one display region unit 12 is, for example, approximately ten thousands.

Each pixel is configured as one set of a plurality of sub-pixels which emit a different color, respectively. More specifically, each pixel is configured of three sub-pixels of a red light emitting sub-pixel (sub-pixel R), a green light emitting pixel (sub-pixel G), and a blue light emitting pixel (sub-pixel B). The illustrated display unit 105 is subjected to line-sequential driving. More specifically, the liquid crystal display panel 207 includes a scanning electrode (extending in the first direction) and a data electrode (extending in the second direction) which intersect each other in a matrix, selects the scanning electrode by inputting a scanning signal to the scanning electrode, scans the scanning electrode, displays an image based on a data signal (signal based on control signal) which is input to the data electrode, and configures one screen.

The backlight 208 is a surface light device which is arranged on the rear side of the liquid crystal display panel 207, and illuminates the display region 11 from the rear surface, and may have the direct-type structure in which a light source is arranged immediately below the liquid crystal display panel 207, or the edge light-type structure in which the light source is arranged at the periphery of the light guiding plate. In addition, when performing partial driving, the backlight 208 is configured of P*Q light source units 42 (refer to FIG. 21) which are individually arranged corresponding to the virtual display region units 12 of P*Q. Each light source unit 42 illuminates the display region unit 12 corresponding to the light source unit 42 from the rear surface. In addition, light sources which are provided in the light source unit 42 are individually controlled. In addition, the light guiding plate is arranged in each light source unit 42.

In addition, the backlight 208 is arranged immediately below the liquid crystal display panel 207 in reality; however, in FIG. 19, for convenience, the liquid crystal display panel 207 and the backlight 208 are separately illustrated. In FIG. 21, a configuration example of the direct-type backlight 208 is schematically illustrated. In the example illustrated in FIG. 21, the backlight 208 is configured of a plurality of light source units which are respectively partitioned using a light shielding partitioning body 2101. Each light source unit 42 includes a unit light emitting module in which a plurality of types of monochrome light sources are combined by a predetermined number. In the illustrated example, the unit light emitting module is configured of a light emitting diode unit in which light emitting diodes 41R, 41G, and 41B which are formed of three primary colors of RBG are set as one set. For example, the red light emitting diode 41R emits a red color (for example, wavelength is 640 nm), the green light emitting diode 41G emits a green color (for example, wavelength is 530 nm), and the blue light emitting diode 41B emits a blue color (for example, wavelength is 450 nm). Though it is difficult to understand in FIG. 21 which is a plan view, the light shielding partitioning body 2101 is orthogonally erected on a mounting surface of each monochrome light source, and executes a good gradation control by reducing leaking of irradiation light between each of unit light emitting modules. In addition, in the example illustrated in FIG. 21, each light source unit 42 which is partitioned using the light shielding partitioning body 2101 has a rectangular shape; however, the shape of the light source unit is arbitrary. For example, the shape may be a triangular shape, or a honeycomb shape.

As illustrated in FIGS. 19 and 20, the driving unit which drives the liquid crystal display panel 207 and the backlight 208 based on an image signal which is input from the outside (for example, video encoder 204) is configured of a backlight driving control unit 209 which performs on-off controls of the red light emitting diode 41R, the green light emitting diode 41G, and the blue light emitting diode 41B which configure a backlight 40 based on a pulse width modulation control method, a light source unit driving circuit 80, and an liquid crystal display panel driving circuit 90.

The backlight driving control unit 209 is configured of an operation circuit 71, and a storage unit (memory) 72. In addition, when partial driving is performed, a light emitting state of the light source unit 42 which corresponds to a corresponding display region unit 12 is controlled based on a maximum input signal in the display region unit which has a maximum value x_{U-max} in an input signal corresponding to each display region unit 12.

In addition, the light source unit driving circuit 80 is configured of an operation circuit 81, a storage unit (memory) 82, an LED driving circuit 83, a photodiode control circuit 84, switching elements 85R, 85G, and 85B which are formed of an FET, and light emitting diode driving power source (constant current source) 86.

In addition, the liquid crystal display panel driving circuit 90 is configured of a well-known circuit which is a timing controller 91. In the liquid crystal display panel 207, a gate driver, a source driver, or the like (none of them are illustrated), for driving a the switching element which is formed of a TFT configuring a liquid crystal cell are provided. A feedback mechanism is formed in which a light emitting state of each light emitting diode of 41R, 41G, and 41B in a certain image display frame is respectively measured using the photodiodes 43R, 43G, and 43B, outputs from the photodiodes 43R, 43G, and 43B are input to the photodiode control circuit 84, the outputs are set to data (signal) as luminance and chromacity, for example, of the light emitting diodes 41R, 41G, and 41B in the photodiode control circuit 84 and the operation circuit 81, the data is transmitted to the LED driving circuit 83, and light emitting states of the light emitting diodes 41R, 41G, and 41B in the subsequent image display frame are controlled. In addition, resistive elements for detecting currents r_{R}, r_{G}, and r_{B} are respectively inserted in series with the light emitting diodes 41R, 41G, and 41B on the downstream side of the light emitting diodes 41R, 41G, and 41B. In addition, currents which flow in the resistive elements r_{R}, r_{G}, and r_{B} cause voltage changes, and operations of the light emitting driving power source 86 are controlled under a control of the LED driving circuit 83 so that a voltage drop in the resistive elements r_{R}, r_{G}, and r_{B} becomes a predetermined value. Here, in FIG. 5, only one light emitting driving power source (constant current source) 86 is illustrated; however, actually, light emitting driving power sources 86 for respectively driving the light emitting diodes 41R, 41G, and 41B are arranged.

When performing partial driving, the display region which is configured of pixel which are arranged in a matrix are divided into display region units of P*Q. When this state is expressed using a “row” and a “column”, it can be said that the display region is divided into display region units of Q rows*P columns. In addition, the display region unit 12 is configured of a plurality of (M*N) pixels; however, when this state is expressed using a “row” and a “column”, it can be said that the display region unit is configured of N rows*M columns.

Each pixel is configured of a set of three sub-pixels of a sub-pixel (R) (red light emitting sub-pixel), a sub-pixel (G) (green light emitting sub-pixel), and a sub-pixel (B) (blue light emitting sub-pixel). It is possible to perform a gradation control with respect to respective luminance of the sub-pixels (R, G, B), for example, in stages of 2⁸ of 0 to 255. In this case, values x_{R}, x_{G}, x_{B} of input signals (R, G, B) which are input to the liquid crystal display panel driving circuit 90 have values of 2⁸ stages, respectively. In addition, values S_{R}, S_{G}, S_{B} of pulse width modulation output signals for controlling light emitting times of the red light emitting diode 41R, the green light emitting diode 41G, and the blue light emitting diode 41B which configure each light source unit also have values of 2⁸ stages of 0 to 255. However, there is no limitation to this, and, for example, it is also possible to perform controlling of light emitting times in stages of 2¹⁰ of 0 to 1023 by setting a 10 bit control (expression using numerical values of 8 bit may become, for example, 4 times).

A control signal for controlling light transmittance Lₜ is supplied to each pixel from the driving unit. Specifically, control signals (R, G, B) for controlling each light transmittance Lₜ are supplied to sub-pixels (R, G, B) from the liquid crystal display panel driving circuit 90. That is, in the liquid crystal display panel driving circuit 90, control signals (R, G, B) are generated from the input signals (R, G, B) which are input, and the control signals (R, G, B) are supplied (output) to the sub-pixels (R, G, B). In addition, since light source luminance Y of the backlight 208 or the light source unit 42 is changed in each one pixel display frame, basically, the control signals (R, G, B) have values in which a correction (compensation) based on the change in the light source luminance Y is performed with respect to values in which the values of the input signals (R, G, B) are subjected to a gamma correction. In addition, control signals (R, G, B) are transmitted to the gate driver and the source driver of the liquid crystal display panel 207 from the timing controller 91 which configures the liquid crystal display panel driving circuit 90, and the light transmittance (aperture ratio) Lₜ of each sub-pixel is controlled when a switching element which configures each sub-pixel is driven based on the control signal (R, G, B), and a desired voltage is applied to a transparent electrode which configures a liquid crystal cell. Here, the larger the value of the control signal (R, G, B), the higher the light transmittance (aperture ratio of sub-pixel) Lₜ of sub-pixels (R, G, B), and the higher the luminance (display luminance y) value of the sub-pixel (R, G, B). That is, an image (usually, one type, and is dot shape) which is configured using light which passes through the sub-pixel (R, G, B) becomes bright.

The controls of the display luminance y and the light source luminance Y are performed in each one image display frame in an image display of the display unit 105, in each display region unit, and in each light source unit. In addition, operations of the liquid crystal display panel 207 and operations of the backlight 208 in one image display frame are synchronized.

FIGS. 19 and 20 illustrate configuration examples of the display unit 105 in which a liquid crystal display is used; however, even when a device other than the liquid crystal display is used, it is also possible to execute the technology which is disclosed in the present disclosure, similarly. For example, it is possible to apply a MEMS display (for example, refer to PTL 5) in which MEMS shutter is driven on a TFT substrate to the technology which is disclosed in the present disclosure.

In addition, the technology which is disclosed in the present disclosure is not limited to a specific pixel arrangement structure such as a three primary color pixel structure of RGB. For example, the structure may be a pixel structure including colors of one or more in addition to the three primary color pixels of RGB, specifically, the structure may be a four color pixel structure of RGBW including a white pixel in addition to the three primary color pixels of RGB, or a four color pixel structure of RGBY including a yellow pixel in addition to the three primary color pixels of RGB.

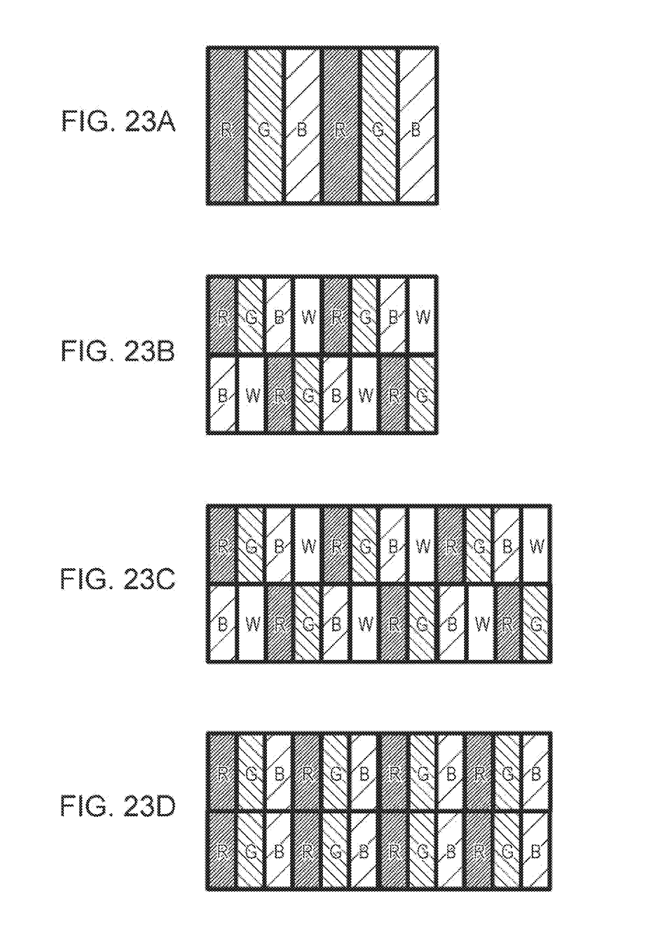

In FIGS. 23A to 23D, pixel arrangement structures are exemplified. In FIG. 23A, one pixel is configured of three sub-pixels of RGB, and a resolution thereof is 1920*RGB (3)*1080. In addition, in FIG. 23B, one pixel is configured of two sub-pixels of RG or BW, and resolution thereof is 1920*RGBW(4)*2160. In addition, in FIG. 23C, two pixels are configured of five sub-pixels of RGBWR, and resolution thereof is 2880*RGBW(4)*2160. In addition, in FIG. 23D, one pixel is configured of three sub-pixels of RGB, and resolution thereof is 3840*RGB(3)*2160. In addition, the technology which is disclosed in the present disclosure is not limited to specific resolution.

In addition, the backlight 208 may have an edge light-type structure in which a light source is arranged at the periphery of the light guiding plate, in addition to the direct-type structure (as described above) in which a light source is arranged immediately below the liquid crystal display panel 207. When the backlight is the edge light type which is the latter, it is possible to make the backlight 208 thin easily. An edge light-type backlight (refer to PTL 6) in which a multilayered light guiding plate which executes a brightness control in each display region is used by being overlappingly arranged with a plurality of light guiding plates of which positions of maximum luminance of output light are different from each other may be used.

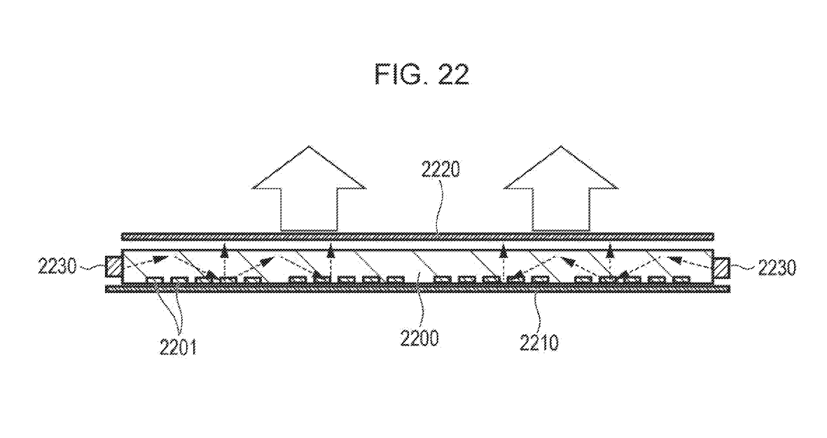

FIG. 22 illustrates a cross-sectional view of a light guiding plate with a single layer structure. A rear surface reflecting plate 2210 is overlapped with the rear surface of a light guiding plate 2200, and a number of dot patterns 2201 which diffuse irradiation light are formed in the inside thereof. In addition, an optical film 2220 is overlapped with the front surface of the light guiding plate 2200. In addition, illumination light beams are input from a plurality of LEDs 2230 from the side surface of the light guiding plate 2200. The input light is propagated inside the light guiding plate 2200 while being reflected on the rear surface reflecting plate 2210, is diffused using the dot pattern 2201, and is radiated to the outside from the front surface by passing through the optical film 2220.

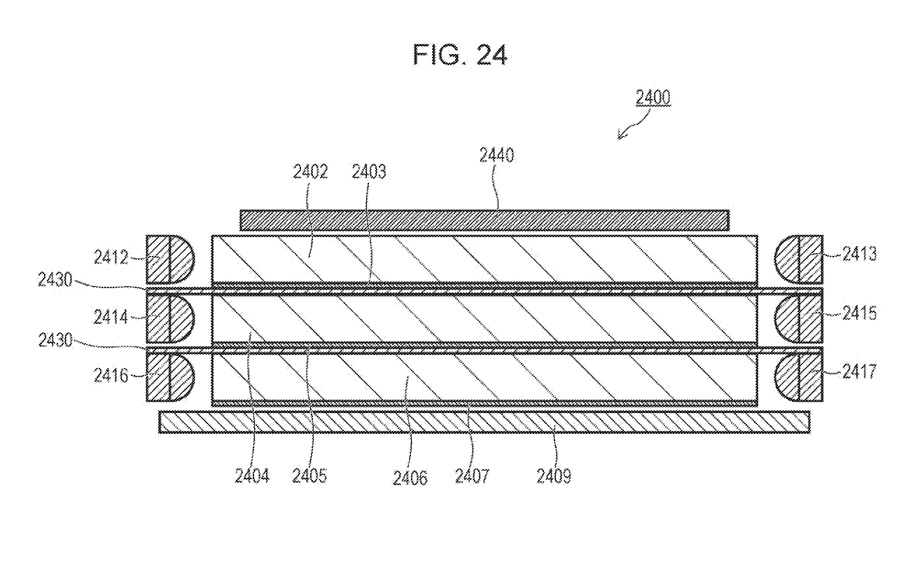

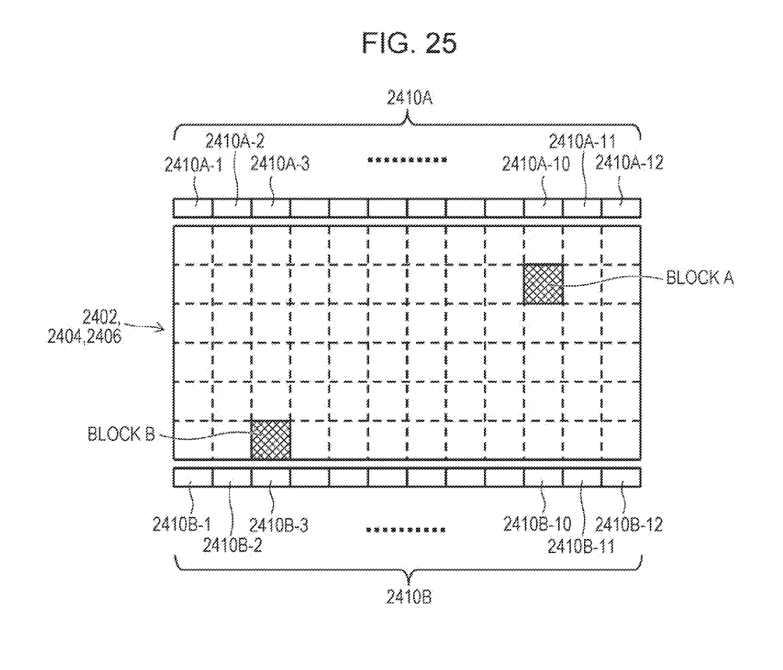

FIG. 24 schematically illustrates a cross-sectional configuration example of an edge light-type backlight 2400 in which a multilayer light guiding plate is used. In addition, FIG. 25 illustrates a state in which a light emitting face (light output face) of the backlight 2400 is viewed from above.

The backlight 2400 includes a three layered light guiding plates of 2402, 2404, and 2406 which are overlappingly arranged, diffusion reflection patterns 2403, 2405, and 2407, a reflecting sheet 2409, light sources 2412, 2413, 2414, 2415, 2416, and 2417 (hereinafter, also referred to as “light source 2410”, collectively) which are formed of LEDs, an interlayer reflecting sheet 2430, and an optical sheet 2440. In addition, members for supporting each unit, or the like, are necessary; however, they are omitted in order to simplify drawings.

The light guiding plates 2402, 2404, and 2406 are overlappingly arranged on the light emitting face in this order. As illustrated in FIG. 25, light source blocks 2410A and 2410B are respectively arranged on the side end face of each of light guiding plates 2402, 2404, and 2406 which are facing each other. The light source 2410 is an LED of R, G, or B, a white LED, or a laser light source. In the example illustrated in FIG. 24, the light sources 2412 and 2413 are respectively provided on side end faces of the light guiding plate 2402 which are facing each other. Similarly, the light sources 2414 and 2415 are respectively provided on side end faces of the light guiding plate 2404 which are facing each other, and the light sources 2416 and 2417 are respectively provided on side end faces of the light guiding plate 2406 which are facing each other.

According to the embodiment, it is assumed that the image display device 100 which is used as the display unit 105 in FIG. 1, and FIGS. 10 to 12 has an ability to display an HDR image.

Meanwhile, an image which is input to the image display device 100 is basically an SDR image by taking into consideration the fact that most of home televisions only corresponds to a general luminance display. For example, in an SDR image in which a luminance dynamic range of contents which are produced as an HDR image, originally, is edited by being compressed, gradation deteriorates, and a sense of reality is lost. When the display unit 105 of the image display device 100 corresponds to a high luminance display, in order to view the input SDR image as an HDR image, a process of getting closer to brightness in a real space may be performed by performing an extension process with respect to the luminance dynamic range.

However, when definition information of compression is delivered only as an incomplete form, or is not delivered at all from a contents supply source, it is not possible to ascertain an accurate method of extension on the receiver side. For example, when Knee extension is performed in a state in which definition information of Knee compression is not accurate, or is unknown, there is a problem in that it is not possible to restore compressed high luminance signal information, and to restore Knee compression when performing editing. In addition, also in a case in which contents which are originally produced using a low luminance dynamic range or a standard luminance dynamic range are converted into a high dynamic range image, it is difficult to express natural high luminance signal information.

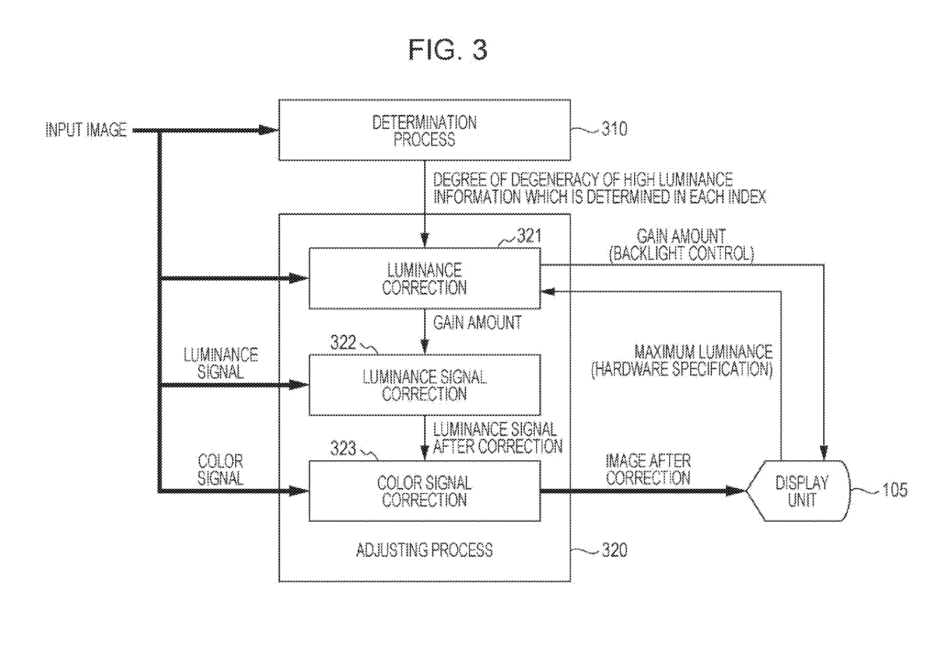

Therefore, in the present disclosure, a method in which a low dynamic range image or a standard dynamic range image is converted into a high dynamic range image while expressing natural high luminance signal information will be presented. FIG. 3 schematically illustrates a processing procedure thereof.

A process of restoring high luminance signal information of an input image is configured of a determination process 310, and an adjusting process 320. In the determination process 310, a degree of degeneracy of high luminance signal information of an input image is determined. In addition, in the adjusting process 320, brightness of an input image is adjusted so as to be close to brightness in a real space based on a determination result due to the determination process 310. The adjusting process 320 includes a luminance correction process 321, a luminance signal correction process 322, and a color signal correction process 323. Hereinafter, each process will be described.

### [Determination Process]

For example, when metadata in which information on luminance compression is described is added to an input image, a degree of degeneracy of high luminance signal information of the input image may be determined based on contents of the metadata. However, hereinafter, a method in a determination process in a case in which there is not information such as metadata at all will be described.

In the determination process 310, a degree of degeneracy of high luminance signal information is determined based on a luminance signal level of an input image.

For example, in a case in which the input image is edited on a master monitor of which white luminance is 100 nit will be assumed. In a case in which the original image is a dark image of approximately 0 nit to 20 nit, compression is not performed in order to suppress the white luminance to 100 nit, and the original image remains in the original dynamic range. On the other hand, in a case in which the original image is a bright image of approximately 0 nit to 1000 nit, a high luminance component is compressed, and the original image is included in a dynamic range of 0 nit to 100 nit.

On the contrary, it is possible to assume that compression is not performed with respect to a dark input image of approximately 0 nit to 20 nit in the process of editing. In addition, it is possible to assume that an input image of approximately 0 nit to 90 nit which is close to the dynamic range of the master monitor is slightly compressed. In addition, it is assumed that a high luminance component of an input image of 0 nit to 100 nit which is equal to a limit of the dynamic range of the master monitor is considerably compressed, and it is necessary to remarkably improve a luminance level in order to restore the original high dynamic range.

Accordingly, in the determination process 310, brightness of the original image of the input image is assumed by setting any one of the following (1) to (4), or a combination of two or more as an index, for example, and a degree of degeneracy of the high luminance signal information is determined.

(1) maximum luminance signal level in input image
(2) amount in vicinity of maximum luminance signal level value in input image
(3) mean value of luminance signal in input image
(4) amount in vicinity of black (low luminance signal) level value in input image

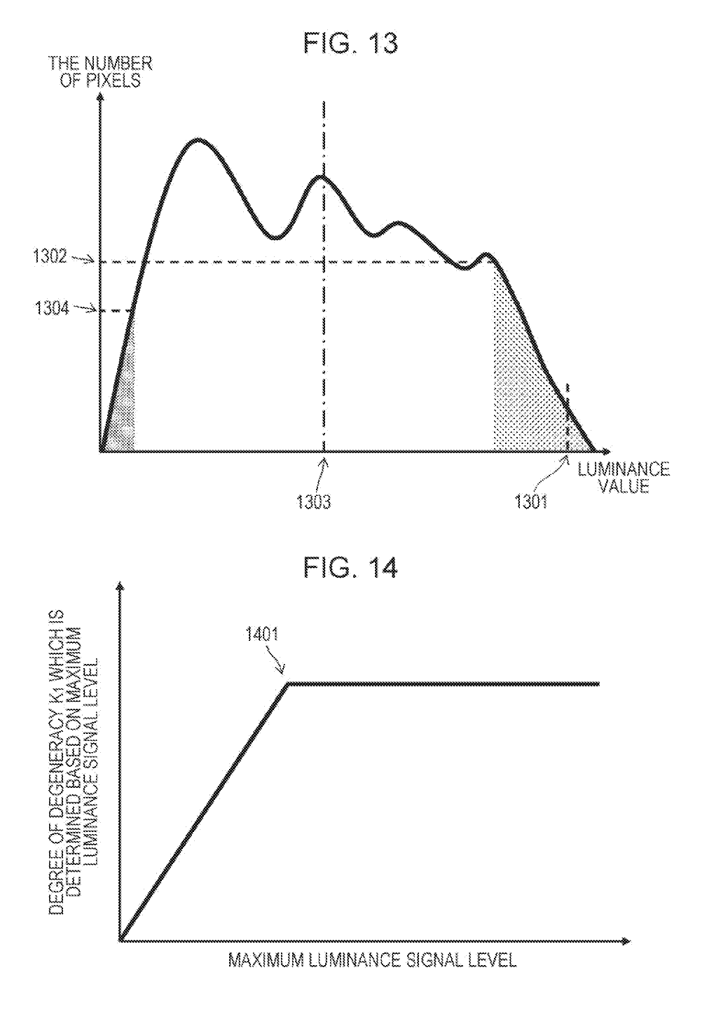

In each determination process of the above described (1) to (4), for example, it is possible to perform determination using a luminance signal histogram of an input image. Alternatively, it is also possible to perform the above described determination processes of (1) to (4) using input signals of R, G, B, and the like, or, for example, a histogram such as V/L/I such as HSV/HSL/HSI which are obtained by processing thereof. Here, descriptions will be made by assuming an input image of a luminance signal histogram as illustrated in FIG. 13.

The maximum luminance signal in an input image in (1) means a luminance signal value of a predetermined level (for example, 90%) with respect to the maximum luminance signal value in the input image. In the luminance signal histogram which is exemplified in FIG. 13, the luminance signal value which is denoted by the reference numeral 1301 corresponds to the maximum luminance signal level. In the determination process 310, for example, a degree of degeneracy K₁ is determined based on the maximum luminance signal level with respect to an input image with reference to a table in which the degree of degeneracy K₁ of high luminance signal information with respect to the maximum luminance signal level is described which is illustrated in FIG. 14. The degree of degeneracy K₁ of high luminance signal information which is obtained here corresponds to a gain amount of the backlight 208 based on the maximum luminance signal level with respect to the input image. In addition, in the example illustrated in FIG. 14, in the table of the degree of degeneracy K₁ of the high luminance signal information based on the maximum luminance signal level, the degree of degeneracy K₁ of the high luminance signal information monotonously increases according to the maximum luminance signal level in a range in which the maximum luminance signal level is low, and the degree of degeneracy K₁ of the high luminance signal information becomes a constant value when the maximum luminance signal level reaches a certain predetermined value or more, like the curved line which is denoted by the reference numeral 1401; however, it is merely an example.

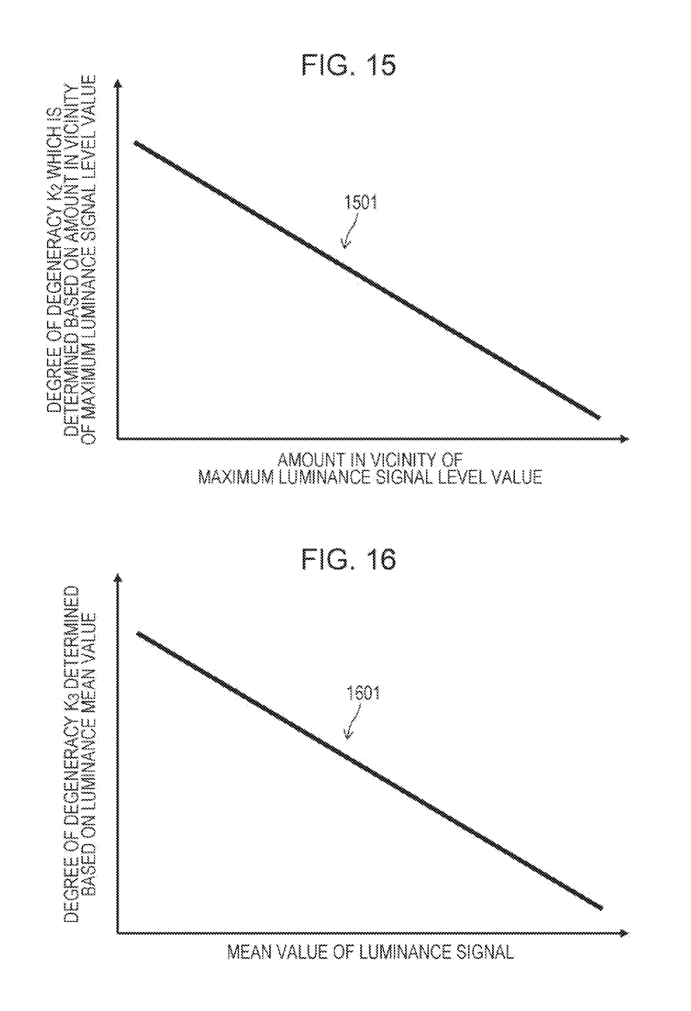

In addition, the amount in the vicinity of a maximum luminance signal level value in an input image in (2) means an amount of pixels in the vicinity of the maximum luminance signal in an input image (for example, pixel with luminance signal value of 80% of maximum luminance signal or more). In the luminance signal histogram which is exemplified in FIG. 13, the number of pixels which is denoted by the reference numeral 1302 corresponds to the amount in the vicinity of the maximum luminance signal level value. In the determination process 310, a degree of degeneracy of the high luminance signal information K₂ based on the amount in the vicinity of the maximum luminance signal level value with respect to an input image is determined with reference to a table in which the degree of degeneracy K₂ of the high luminance signal information with respect to the amount in the vicinity of the maximum luminance signal level value is described as illustrated in FIG. 15, for example. The degree of degeneracy K₂ obtained here corresponds to a gain amount of the backlight 208 based on the amount in the vicinity of the maximum luminance signal level value with respect to an input image. In addition, in the example illustrated in FIG. 15, in the table of the degree of degeneracy K₂ of the high luminance signal information based on the amount in the vicinity of maximum luminance signal level value, the degree of degeneracy K₂ of the high luminance signal information monotonously decreases according to an increase of the amount in the vicinity of the maximum luminance signal level value, like the curved line which is denoted by the reference numeral 1501; however, it is merely an example.

In addition, the mean value of the luminance signal in an input image in (3) means arithmetic mean of a luminance signal value which pixels in an input image have. In the luminance signal histogram which is exemplified in FIG. 13, the luminance signal level which is denoted by the reference numeral 1303 corresponds to a mean value of a luminance signal. However, a median value or a mode value may be used as the mean value of the luminance signal instead of arithmetic mean. In the determination process 310, for example, a degree of degeneracy K₃ of the high luminance signal information based on a mean value of a luminance signal level with respect to an input image is determined with reference to a table in which the described degree of degeneracy K₃ of the high luminance signal information with respect to a mean value of the luminance signal as illustrated in FIG. 16. The degree of degeneracy K₃ obtained here corresponds to a gain amount of the backlight 208 based on the mean value of the luminance signal with respect to an input image. In addition, in the example illustrated in FIG. 16, in the table of the degree of degeneracy K₃ of the high luminance signal information based on the mean value of the luminance signal, the degree of degeneracy K₃ of the high luminance signal information monotonously decreases according to an increase of the mean value of the luminance signal, like the curved line which is denoted by the reference numeral 1601; however, it is merely an example.

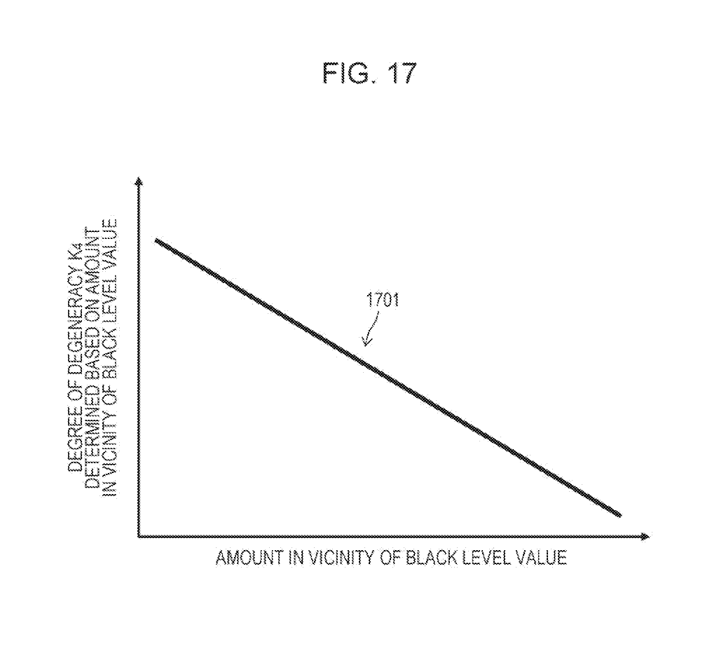

In addition, the amount in the vicinity of a black (low luminance signal) level value in an input image in (4) means an amount of pixels in the vicinity of the black in an input image (for example, pixels of which luminance signal value is predetermined value or less). In the luminance signal histogram which is exemplified in FIG. 13, the number of pixels which is denoted by the reference numeral 1304 corresponds to an amount in the vicinity of a black level value. In the determination process 310, for example, a degree of degeneracy K₄ of the high luminance signal information based on the amount in the vicinity of the black level value with respect to an input image is determined with reference to a table in which the degree of degeneracy of the high luminance signal information K₄ with respect to the amount in the vicinity of the black level value is described as illustrated in FIG. 17. The degree of degeneracy K₄ obtained here corresponds to a gain amount of the backlight 208 based on the amount in the vicinity of the black level value with respect to an input image.

In addition, in the example illustrated in FIG. 17, in the table of the degree of degeneracy K₄ of the high luminance signal information based on the amount in the vicinity of the black level value, the degree of degeneracy K₄ of the high luminance signal information monotonously decreases according to an increase of the amount in the vicinity of the maximum luminance signal level value, like the curved line which is denoted by the reference numeral 1701; however, it is merely an example. For example, in a case in which a black level value is regarded as important, the table in which the degree of degeneracy K₄ of high luminance signal information monotonously decreases according to an increase of the amount in the vicinity of the maximum luminance signal level value may be used. In contrast to this, in a case in which brightness of an input image is regarded as important, a table in which the degree of degeneracy K₄ of high luminance signal information increases according to an increase of the amount in the vicinity of the maximum luminance signal level value (not illustrated) may be used. For example, a table which is used may be used by being adaptively switched according to a scene determination result of an input image, a category of contents, metadata which is associated with the contents, a contents viewing environment, and the like.

### [Adjusting Process]

In the adjusting process 320, a luminance correction 321, a luminance signal correction 322, and a color signal correction 323 are performed in order.

First, as the luminance correction 321, luminance is improved in all gradations according to the degree of degeneracy (K₁, K₂, K₃, and K₄) of the high luminance signal information which are determined in the determination process 310. For example, when the display unit 105 is configured of the liquid crystal display panel 207 as illustrated in FIG. 2, a gain amount of the backlight 208 is improved according to the degree of degeneracy of high luminance signal information. Specifically, as the process of the luminance correction 321, a gain amount K (=K₁*K₂*K₃*K₄) of the backlight is calculated by, for example, multiplying degrees of degeneracy which are obtained with respect to each index (1) to (4), and is output to the backlight driving control unit 209.

However, when the calculated gain amount is provided as is, there is a concern that the gain amount may exceed the maximum luminance (limit of hardware) of the display unit 105. Therefore, at a time of the process of the luminance correction 321, a gain amount K which does not exceed information denoting the maximum luminance of the display unit 105 is output to the backlight driving control unit 209 with reference to the information.

In addition, in the display unit 105, when partial driving of the backlight 208 and a technology of thrusting are applied, it is possible to make luminance in a case in which power which is suppressed at a dark portion is distributed to a region with high luminance, is intensively emitted, and a white display is partially performed higher than the maximum luminance when the partial driving and the technology of thrusting are not applied (which will be described later). Therefore, at a time of the process of the luminance correction 321, the gain amount K of the backlight 208 may be determined based on the maximum luminance when the partial driving and the technology of thrusting are performed, by analyzing the input image.

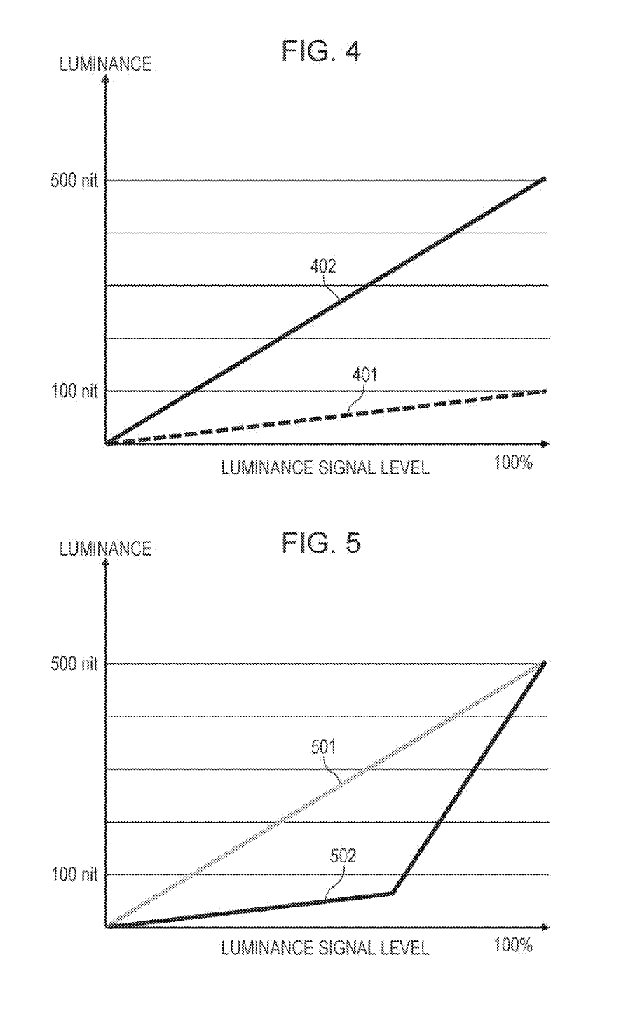

As the process of the luminance correction 321, when the gain amount K of the backlight 208 is improved, luminance of an input image is improved in all gradations. FIG. 4 illustrates a state in which luminance 401 of an input image is improved as denoted by the reference numeral 402 in all gradations. In FIG. 4, a relationship 401 between the luminance signal level before the luminance correction process and the luminance is denoted using a dotted line, and a relationship 402 between the luminance signal level after the process and the luminance is denoted using a solid line. In addition, for convenience, each of relationships 401 and 402 is drawn using a straight line; however, it may be a curved line such as exponential function.

In the input image, since information on the high luminance signal side is compressed, it is desired that luminance on the high luminance side is restored. In the process of luminance correction 321, basically, only the gain amount K of the backlight 208 is improved. Accordingly, as illustrated in FIG. 4, it is only possible to improve luminance almost uniformly from a low luminance region to a high luminance region using simple linear scaling. However, when converting of a luminance dynamic range of an image is performed on the contents producer side, it is presumed that a process of greatly compressing a dynamic range in the high luminance region is performed, while maintaining information in the low luminance region. Therefore, in the subsequent process of luminance signal correction 322, a signal curve is optimized with respect to degenerated gradation and gradation which is not degenerated. The process of luminance signal correction 322 may be performed in any one of color spaces of YCC, RGB, and HSV.

Specifically, in the luminance signal correction 322, a signal process of degenerating a luminance signal is performed according to a degree of luminance correction (according to gain amount of backlight 208) on the low luminance side and the intermediate luminance side. FIG. 5 illustrates a state in which luminance 501 of an input image after a luminance correction is corrected as denoted by the reference numeral 502 due to a luminance signal correction.

As illustrated in FIG. 5, for example, there is a case in which hue is changed when being optimized using a signal curve of a luminance signal. When it is necessary to correct the change in hue completely, or to some extent, in the subsequent color signal correction 323, the original hue is maintained by performing a reverse correction with respect to the change when the hue is changed associated with the correction of luminance signal. In the color signal correction 323, for example, a chroma signal is corrected so that a ratio of the luminance signal to the chroma signal becomes constant before and after correcting the luminance signal.

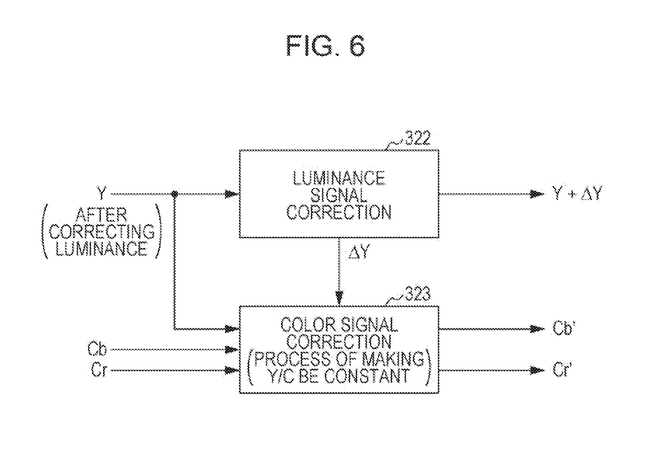

In FIG. 6, as the color signal correction 323, a functional configuration in which the chroma signal is corrected so that the ratio of the luminance signal to the chroma signal becomes constant before and after correcting the luminance signal is schematically illustrated.

In the luminance signal correction 322, a luminance signal Y after performing the luminance correction 321 due to an improvement in gain, or the like, of the backlight 208 is input, and a luminance signal Y+deltaY is output.

In addition, in the color signal correction 323, input chroma signals Cb and Cr are corrected so that a ratio of the luminance signal Y to a chroma signal C becomes constant by inputting the luminance signal Y, the chroma signals Cb and Cr, and the luminance signal correction deltaY. Specifically, according to the following expressions (1) and (2), the input chroma signals Cb and Cr are corrected so as to be output chroma signals Cb′ and Cr′.

[Math. 1]

C_{b}′=C_{b}×(1+ΔY/Y) (1)

[Math. 2]

Cᵣ′=Cᵣ×(1+ΔY/Y) (2)

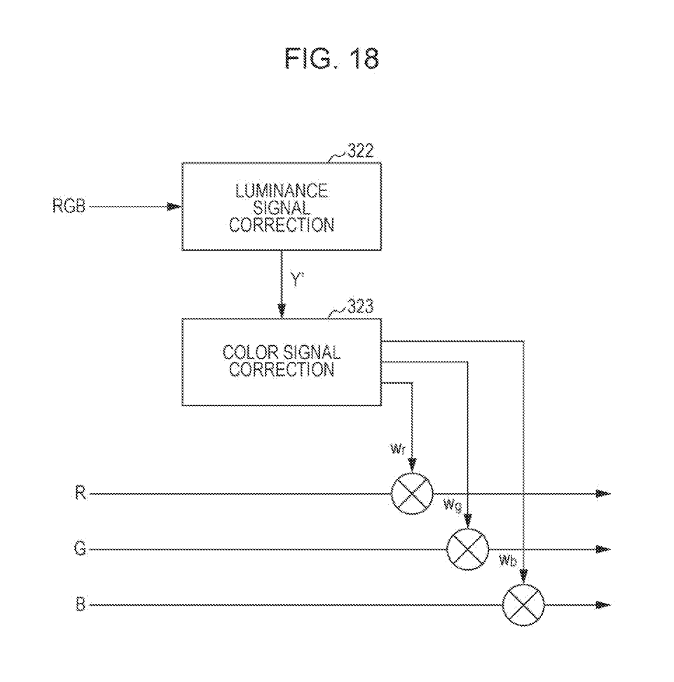

The functional configuration illustrated in FIG. 6 is an example for performing a luminance signal correction and a color signal correction in a YCC space. A functional configuration example in which a luminance signal correction and a color signal correction are performed in a RGB space is illustrated in FIG. 18.

In the luminance signal correction 322, a process of optimizing a signal curve of a luminance signal is performed after calculating a luminance signal Y from an RGB image signal according to the following expression (3), as described with reference to FIG. 5, and a luminance signal Y′ after correction is output.

[Math. 3]

Y=aR+bG+cB (3)

In addition, in the color signal correction 323, a color signal correction is performed by multiplying correction coefficients wᵣ, w_{g}, w_{b} by each color component of RGB based on the luminance signal Y′ after correction.

In this manner, it is possible to realize brightness which is almost close to that in a real space by converting an image which is compressed into a low dynamic range or a standard dynamic range into a high dynamic range image as if it were an image in a high dynamic range. In addition, it is possible to express natural high luminance signal information by performing the luminance signal correction process and the color signal correction process which are illustrated in FIGS. 3, 6, and 18, even in a case in which contents which are originally produced in a low dynamic range or a standard dynamic range are converted into a high dynamic range image.

### [Partial Driving and Thrusting]

It is possible to further improve a dynamic range by combining partial driving and a thrusting technology with a technology of realizing brightness which is close to brightness in a real space by restoring high luminance signal information of an image. The partial driving is a technology which controls a lighting location of a backlight, and it is possible to improve luminance contrast by lighting a backlight corresponding to a region with a high signal level brightly, and on the other hand, by lighting a backlight corresponding to a region with a low signal level darkly (for example, refer to PTL 3). In addition, it is possible to execute higher contrast by causing power which is suppressed at a dark portion to be intensively emitted by distributing the power to a region with a high signal level, for example, by performing luminance thrusting in which luminance is increased when partially performing a white display (in a state in which overall output power of backlight is constant) (for example, refer to PTL 4).

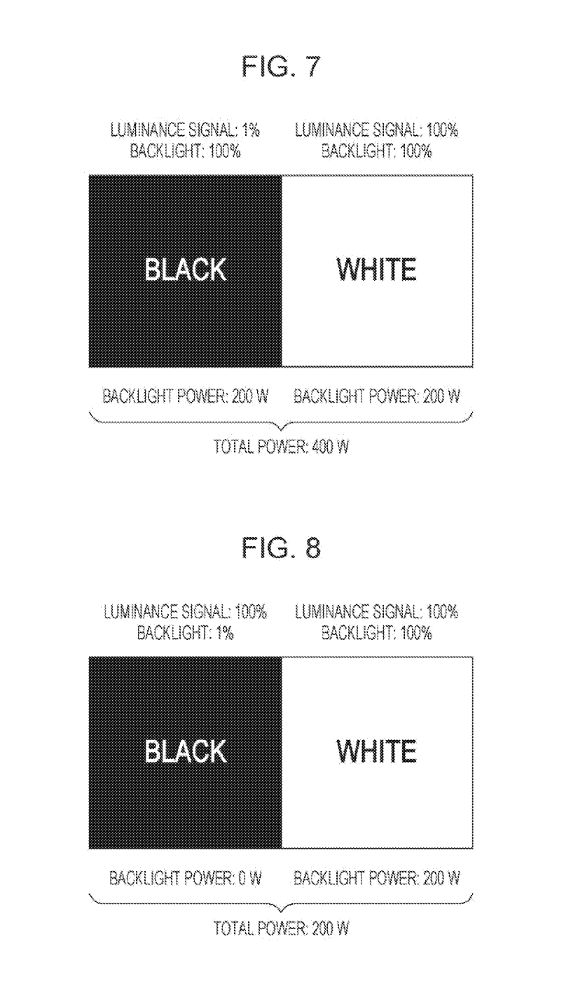

In order to make descriptions simple, descriptions will be made with reference to FIGS. 7 to 9 by exemplifying an input image in which a left half part is a black region of which a luminance level is 1%, and a right half part is a white region of which a luminance level is 100%.

In the example illustrated in FIG. 7, in the entire screen, gain of the backlight 208 is set to 100%, a luminance signal level in the left half part of the liquid crystal display panel 207 is set to 1%, and a luminance signal level in the right half part is set to 100%, thereby drawing an image. In addition, output power when the backlight 208 is 100% lit on the entire screen is set to a maximum of 400 W.

In the example illustrated in FIG. 8, in order to draw an image with the same luminance as that in FIG. 7 (left half part is black region with luminance level of 1%, and right half part is white region with luminance level of 100%), power of the backlight 208 is lowered by raising a luminance signal. By raising a luminance signal level of the left half part of the liquid crystal display panel 207 up to 100%, gain of the backlight of the left half part is lowered to 1%. On the other hand, the luminance signal level of the right half part is 100%, and gain of the backlight of the right half part remains at 100%. When power of the left half part of the backlight 208 becomes 1%, a total power becomes approximately 200 W.

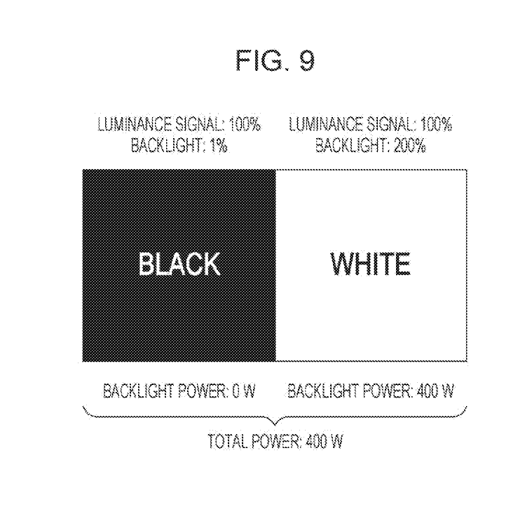

The power of the backlight 208 may be maximum 400 W or less in total. Accordingly, as illustrated in FIG. 8, it is possible to use surplus power which is obtained by saving power in the left half part of the backlight 208 in the right half part. In the example illustrated in FIG. 9, a luminance signal level in the left half part of the liquid crystal display panel 207 is set to 100%, and gain of the backlight in the left half part is set to 1%. On the other hand, it is possible to raise the gain of the backlight up to 200% even though the luminance signal level in the right half part is 100%. In this manner, a high luminance dynamic range is increased two-fold. In addition, it is possible to make power in the entire backlight 208 not exceed the maximum power of 400 W.

### INDUSTRIAL APPLICABILITY

Hitherto, the technology which is disclosed in the present disclosure has been described in detail with reference to specific embodiments. However, it is clear that those skilled in the art can perform a correction or substitution of the embodiment without departing from the scope of the technology which is disclosed in the present disclosure.

According to the technology which is disclosed in the present disclosure, it is possible to convert an image which is subjected to Knee compression so as to be in a low dynamic range or a standard luminance dynamic range into an image with a high dynamic range which is close to brightness in a real space without the definition information of the Knee compression. In addition, the technology which is disclosed in the present disclosure can also be applied to a case in which contents which are originally produced in a low dynamic range or a standard luminance dynamic range are converted into a high dynamic range image, and it is possible to express natural high luminance signal information.

The technology which is disclosed in the present disclosure can be applied to various devices which can display or output an HDR image, for example, a monitor display which is used in an information device such as a television receiver, a personal computer, or the like, and a multifunction terminal such as a game machine, a projector, a printer, a smart phone, and a tablet.

In addition, in the technology which is disclosed in the present disclosure, it is possible to make brightness to be close to that in a real space by restoring compressed high luminance signal information of an input image, by being applied to both a still image and a moving image.

In brief, the technology which is disclosed in the present disclosure has been described in a form of exemplification, and described contents of the present disclosure are not to be restrictively interpreted. In order to determine the scope of the technology which is disclosed in the present disclosure, claims should be considered.

The present technology may also be configured as below.

(1) An image processing apparatus including:
a processing device that determines a degree of degeneracy of high luminance signal information of an input image, and obtains a luminance signal curve based on the degree of degeneracy.
(2) The apparatus according to (1),
wherein the degree of degeneracy is determined based on a luminance signal level of the input image.
(3) The apparatus according to (1) or (2),
wherein the processing device controls luminance of individual light emission units, in accordance with the luminance signal curve.
(4) The apparatus according to any of (1) to (3),
wherein the luminance is controlled according to gradation.
(5) The apparatus according to any of (1) to (4),
wherein the luminance is controlled according to all gradations.
(6) The apparatus according to any of (1) to (5)
wherein at least one of the light emission units is a light emitting diode.
(7) The apparatus according to any of (1) to (6),
wherein the processing device controls power of a backlight of a display device, in accordance with the luminance signal curve.
(8) The apparatus according to any of (1) to (7),
wherein the power of individual light emission units of the backlight is controlled, in accordance with the luminance signal curve, by reducing power of a first light emission unit of the light emission units by a first power amount and increasing power of a second light emission unit of the light emission units by a portion of the first power amount.
(9) The apparatus according to any of (1) to (8),
wherein the power of the second light emission unit is increased by the portion of the first power amount, such that the power of the second light emission unit is greater than a power at which each of the light emission units is set when the backlight is 100% lit on the screen in accordance with a luminance signal level set to 100%.
(10) The apparatus according to any of (1) to (9),
wherein the processing device controls a chroma signal, in accordance with the luminance signal curve.
(11) The apparatus according to any of (1) to (10),
wherein the chroma signal is determined using a luminance signal correction value, the luminance signal correction value being in accordance with the luminance signal curve.
(12) The apparatus according to any of (1) to (11),
wherein the chroma signal is controlled so a ratio of a luminance signal, in accordance with the luminance signal curve, to the chroma signal is same as a ratio of a luminance signal indicating luminance of the input image to a chroma signal indicating hue of the input image.
(13) The apparatus according to any of (1) to (12),
wherein the chroma signal is controlled to maintain an original hue of the input image.
(14) An image processing method including:
determining, by a processing device, a degree of degeneracy of high luminance signal information of an input image, and obtaining, by the processing device, a luminance signal curve based on the degree of degeneracy.
(15) A non-transitory storage medium on which is recorded a program for image processing, the program including:
determining a degree of degeneracy of high luminance signal information of an input image, and obtaining a luminance signal curve based on the degree of degeneracy.
(16) A display apparatus including:
a processing device that determines a degree of degeneracy of high luminance signal information of an input image, and obtains a luminance signal curve based on the degree of degeneracy; and
a display device including a backlight configured by a plurality of light emission units, wherein the processing device controls power of the individual light emission units, in accordance with the luminance signal curve.
(17) The display apparatus according to (16),
wherein the processing device controls luminance of the individual light emission units, in accordance with the luminance signal curve.
(18) The display apparatus according to (16) or (17),
wherein the luminance is controlled according to gradation.
(19) The display apparatus according to any of (16) to (18), wherein
the degree of degeneracy is determined based on a luminance signal level of the input image.
(20) The display apparatus according to any of (16) to (19), wherein
the light emission units include light emitting diodes.

In addition, it is also possible to adopt the following configuration in the technology which is disclosed in the present disclosure.

(1) An image processing device including:
a determination unit which determines a degree of degeneracy of high luminance signal information of an input image; and
an adjusting unit which adjusts the input image based on a determination result using the determination unit.
(2) The image processing device which is described in (1), in which the adjusting unit includes a luminance correction unit which corrects luminance based on the determination result using the determination unit; a luminance signal correction unit which corrects a luminance signal according to gradation; and a color signal correction unit which corrects a change in hue which is associated with the correction of the luminance signal.
(3) The image processing device which is described in (2), in which the luminance correction unit improves luminance in all gradations according to a degree of degeneracy of high luminance signal information which is determined by the determination unit.
(4) The image processing device which is described in (2), in which the luminance signal correction unit optimizes a signal curve with respect to gradation which is degenerated, and gradation which is not degenerated.
(5) The image processing device which is described in (2), in which the color signal correction unit maintains original hue by performing a reverse correction with respect to a change when the hue is changed associated with the correction of the luminance signal which is performed using the luminance signal correction unit.
(6) The image processing device which is described in (2), in which the color signal correction unit corrects a chroma signal so that a ratio of a luminance signal to the chroma signal becomes constant before and after correcting the luminance signal.
(7) The image processing device which is described in (1), in which the determination unit determines a degree of degeneracy of high luminance signal information thereof based on a luminance signal level of an input image.
(8) The image processing device which is described in (1), in which the determination unit determines the degree of degeneracy of the high luminance signal information based on at least one of a maximum luminance signal level in an input image, an amount in the vicinity of a value of the maximum luminance signal level in the input image, a mean value of a luminance signal in the input image, and an amount in the vicinity of a value of a black level in the input image.
(9) An image processing method including:
determining a degree of degeneracy of high luminance signal information of an input image; and
adjusting the input image based on a determination result in the determining.
(10) An image display device including:
a determination unit which determines a degree of degeneracy of high luminance signal information of an input image;
an adjusting unit which adjusts the input image based on a determination result using the determination unit; and
a display unit which displays the image which is adjusted.

### REFERENCE SIGNS LIST

100 Image display device
101 Antenna
102 Tuner
103 Digital demodulation unit
104 Digital decoder
105 Display unit
111 Media reproduction unit
121 Communication unit
131 HDMI (registered trademark) interface unit
201 Input terminal
202 Video decoder
203 Control signal generation unit
204 Video encoder
205 Data driver
206 Gate driver
207 Liquid crystal display panel
208 Backlight
209 Backlight driving control unit
210 Power source

1. An image processing apparatus comprising:
a processing device that determines a degree of degeneracy of high luminance signal information of an input image, and obtains a luminance signal curve based on the degree of degeneracy.

2. The apparatus of claim 1, wherein the degree of degeneracy is determined based on a luminance signal level of the input image.

3. The apparatus of claim 1, wherein the processing device controls luminance of individual light emission units, in accordance with the luminance signal curve.

4. The apparatus of claim 3, wherein the luminance is controlled according to gradation.

5. The apparatus of claim 4, wherein the luminance is controlled according to all gradations.

6. The apparatus of claim 3, wherein at least one of the light emission units is a light emitting diode.

7. The apparatus of claim 1, wherein the processing device controls power of a backlight of a display device, in accordance with the luminance signal curve.

8. The apparatus of claim 7, wherein the power of individual light emission units of the backlight is controlled, in accordance with the luminance signal curve, by reducing power of a first light emission unit of the light emission units by a first power amount and increasing power of a second light emission unit of the light emission units by a portion of the first power amount.

9. The apparatus of claim 8, wherein the power of the second light emission unit is increased by the portion of the first power amount, such that the power of the second light emission unit is greater than a power at which each of the light emission units is set when the backlight is 100% lit on the screen in accordance with a luminance signal level set to 100%.

10. The apparatus of claim 1, wherein the processing device controls a chroma signal, in accordance with the luminance signal curve.

11. The apparatus of claim 10, wherein the chroma signal is determined using a luminance signal correction value, the luminance signal correction value being in accordance with the luminance signal curve.

12. The apparatus of claim 10, wherein the chroma signal is controlled so a ratio of a luminance signal, in accordance with the luminance signal curve, to the chroma signal is same as a ratio of a luminance signal indicating luminance of the input image to a chroma signal indicating hue of the input image.

13. The apparatus of claim 10, wherein the chroma signal is controlled to maintain an original hue of the input image.

14. An image processing method comprising:
determining, by a processing device, a degree of degeneracy of high luminance signal information of an input image, and obtaining, by the processing device, a luminance signal curve based on the degree of degeneracy.

15. A non-transitory storage medium on which is recorded a program for image processing, the program comprising:
determining a degree of degeneracy of high luminance signal information of an input image, and obtaining a luminance signal curve based on the degree of degeneracy.

16. A display apparatus comprising:
a processing device that determines a degree of degeneracy of high luminance signal information of an input image, and obtains a luminance signal curve based on the degree of degeneracy; and
a display device including a backlight configured by a plurality of light emission units,
wherein the processing device controls power of the individual light emission units, in accordance with the luminance signal curve.

17. The display apparatus of claim 16, wherein the processing device controls luminance of the individual light emission units, in accordance with the luminance signal curve.

18. The display apparatus of claim 17, wherein the luminance is controlled according to gradation.

19. The display apparatus of claim 16, wherein the degree of degeneracy is determined based on a luminance signal level of the input image.

20. The display apparatus of claim 16, wherein the light emission units include light emitting diodes.
